(19) United States
(12) Patent Application Publication
(10) Pub. No.: US 2014/0092003 A1
(43) Pub. Date: Apr. 3, 2014

(54) DIRECT HAPTIC FEEDBACK

(71) Applicant: MIN LIU, Portland, OR (US)

(72) Inventor: MIN LIU, Portland, OR (US)

(21) Appl. No.: 13/630,723

(22) Filed: Sep. 28, 2012

(51) Int. Cl. G06F 3/01

(52) U.S. Cl. CPC G06F 3/016
USPC 345/156

(57) ABSTRACT

An electronic device comprises an input device and logic to register one or more input events and one or more haptic effects associated with the one or more input events for an application on an electronic device, receive an input event, retrieve one or more haptics effects, and pass the one or more haptics effects associated with the input event to a haptics actuator. Other embodiments may be described.

### RELATED APPLICATIONS

None.

### BACKGROUND

The subject matter described herein relates generally to the field of electronic devices and more particularly to a system and method to implement haptic feedback on one or more electronic devices.

Some electronic devices such as computers, laptop computers, tablet computers, personal digital assistants, mobile phones, and the like include one or more haptic feedback devices to provide haptic feedback to a user to enhance a user experience of an application. Such haptic feedback devices may include vibration assemblies, adjustable display features such as brightness, contrast, and the like. Accordingly techniques to manage haptic feedback may find utility.

### BRIEF DESCRIPTION OF THE DRAWINGS

The detailed description is described with reference to the accompanying figures.

FIGS. 1-2 are schematic illustrations of exemplary electronic devices which may be adapted to implement haptic feedback in accordance with some embodiments.

FIG. 3 is a schematic illustration of a software stack architecture for the direct haptic feedback in an electronic device, according to embodiments.

FIG. 4 is a flowchart illustrating operations in part of a method to implement the direct haptic feedback in accordance with, according to embodiments.

FIG. 5 is a schematic illustration of an electronic device which may be adapted to implement haptic feedback, according to embodiments.

### DETAILED DESCRIPTION

Described herein are exemplary systems and methods to implement haptic feedback in electronic devices. In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

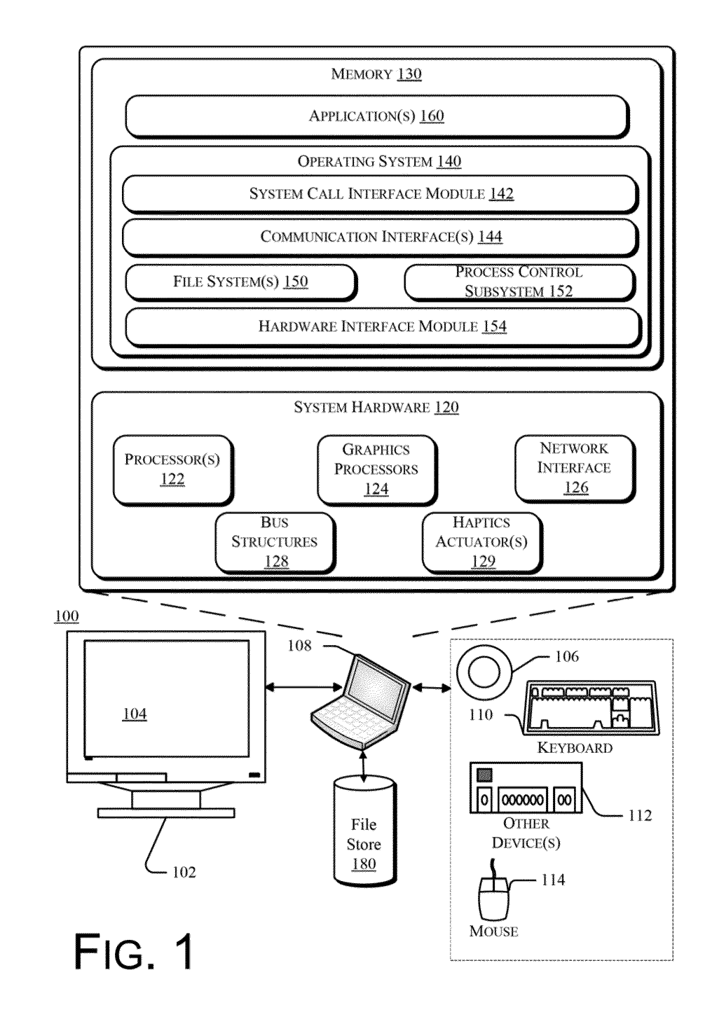

FIG. 1 is a schematic illustration of an exemplary electronic device which may be used to implement haptic feedback adjustment in accordance with some embodiments. In one embodiment, system 100 includes an electronic device 108 and one or more accompanying input/output devices including a display 102 having a screen 104, one or more speakers 106, a keyboard 110, one or more other I/O device(s) 112, and a mouse 114. The other I/O device(s) 112 may include a touch screen, a voice-activated input device, a track ball, motion sensors and any other device that allows the system 100 to receive input from a user.

In various embodiments, the electronic device 108 may be embodied as a personal computer, a laptop computer, a personal digital assistant, a slate or tablet computer, a mobile telephone, an entertainment device, or another computing device. The electronic device 108 includes system hardware 120 and memory 130, which may be implemented as random access memory and/or read-only memory. A file store 180 may be communicatively coupled to computing device 108. File store 180 may be internal to computing device 108 such as, e.g., one or more hard drives or solid-state drives, flash memory, CD-ROM drives, DVD-ROM drives, or other types of storage devices. File store 180 may also be external to computer 108 such as, e.g., one or more external hard drives, network attached storage, or a separate storage network.

System hardware 120 may include one or more processors 122, one or more graphics processors 124, network interfaces 126, bus structures 128, and one or more haptics actuators 129. In one embodiment, processor 122 may be embodied as an Intel® Core2 Duo® processor or an Intel® Atom® Z2760 or an Intel® Atom® Z2460 available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics processor(s) 124 may function as adjunct processor that manages graphics and/or video operations. Graphics processor(s) 124 may be integrated onto the same silicon as the main “processor” as a system-on-chip (SOC), or integrated onto the motherboard of computing system 100 via an expansion slot on the motherboard.

In one embodiment, network interface 126 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 128 connect various components of system hardware 128. In one embodiment, bus structures 128 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

Haptics actuators 129 may include one or more of a vibrating motor, a piezoelectric actuator, an electroactive polymer actuator or any similar device which generates a haptic feedback.

Memory 130 may include an operating system 140 for managing operations of computing device 108. In one embodiment, operating system 140 includes a hardware interface module 154 that provides an interface to system hardware 120. In addition, operating system 140 may include a file system 150 that manages files used in the operation of computing device 108 and a process control subsystem 152 that manages processes executing on computing device 108.

Operating system 140 may include (or manage) one or more communication interfaces that may operate in conjunction with system hardware 120 to transceive data packets and/or data streams from local input devices or a remote source. Operating system 140 may further include a system call interface module 142 that provides an interface between the operating system 140 and one or more application modules resident in memory 130. Operating system 140 may be embodied as a UNIX operating system or any derivative thereof (e.g., Linux, Android, Solaris, etc.) or as a Windows® brand operating system, or other operating systems.

In one embodiment, memory 130 includes one or more applications 160 which execute on the processor(s) 122 under the control of operating system 140. In some embodiments, the application(s) 160 may utilize the graphics processor(s) 124 to display graphics on the display 104 and the haptics actuator(s) 129 to generate haptic feedback to a user of the electronic device 100.

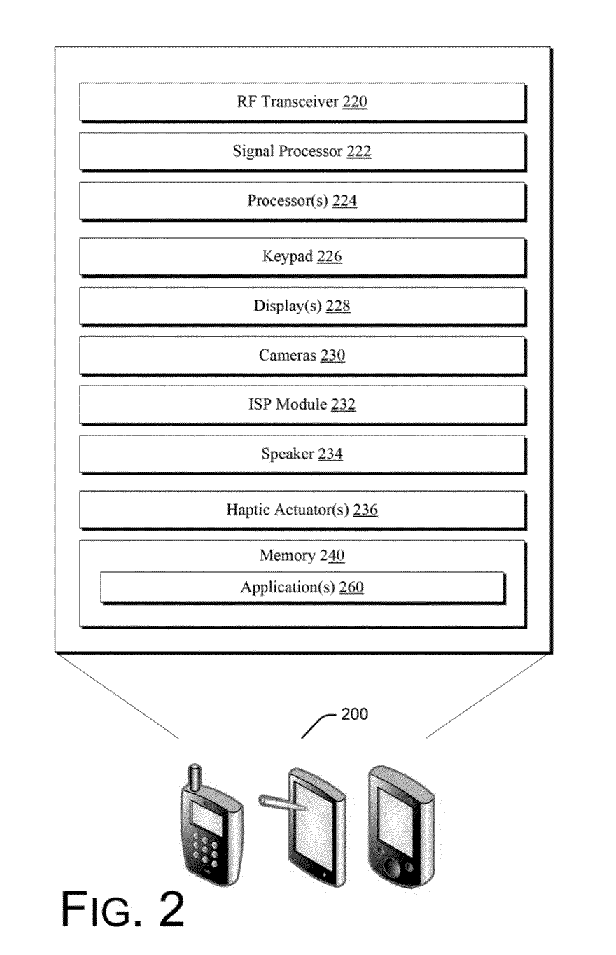

FIG. 2 is a schematic illustration of another embodiment of an electronic device 200 which may be adapted to implement haptic feedback, according to embodiments. In some embodiments electronic device 200 may be embodied as a mobile telephone, a personal digital assistant (PDA), or the like. Electronic device 200 may include an RF transceiver 220 to transceive RF signals and a signal processing module 222 to process signals received by RF transceiver 220.

RF transceiver 220 may implement a local wireless connection via a protocol such as, e.g., Bluetooth or 802.11x. IEEE 802.11a, b or g-compliant interface (see, e.g., IEEE Standard for IT-Telecommunications and information exchange between systems LAN/MAN-Part II: Wireless LAN Medium Access Control (MAC) and Physical Layer (PHY) specifications Amendment 4: Further Higher Data Rate Extension in the 2.4 GHz Band, 802.11 G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Electronic device 200 may further include one or more processors 224 and a memory module 240. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit. In some embodiments, processor 224 may be one or more processors in the family of Intel® PXA27x processors available from Intel® Corporation of Santa Clara, Calif. Alternatively, other CPUs may be used, such as Intel's Itanium®, XEO [symbol] , ATOM™, and Celeron® processors. Also, one or more processors from other manufactures may be utilized. Moreover, the processors may have a single or multi core design. In some embodiments, memory module 240 includes random access memory (RAM); however, memory module 240 may be implemented using other memory types such as dynamic RAM (DRAM), synchronous DRAM (SDRAM), and the like.

Electronic device 200 may further include one or more input/output interfaces such as, e.g., a keypad 226 and one or more displays 228. In some embodiments electronic device 200 comprises one or more camera modules 230 and an image signal processor 232, speakers 234, and one or more haptic actuators, as described with reference to FIG. 1.

In some embodiments electronic device 200 may include a computer readable memory 240 in which one or more applications 260 reside. As described with reference to FIG. 1, the one or more applications 260 may utilize the processor(s) 224 and the haptics actuator(s) 236 to generate haptic feedback to a user of the electronic device 200.

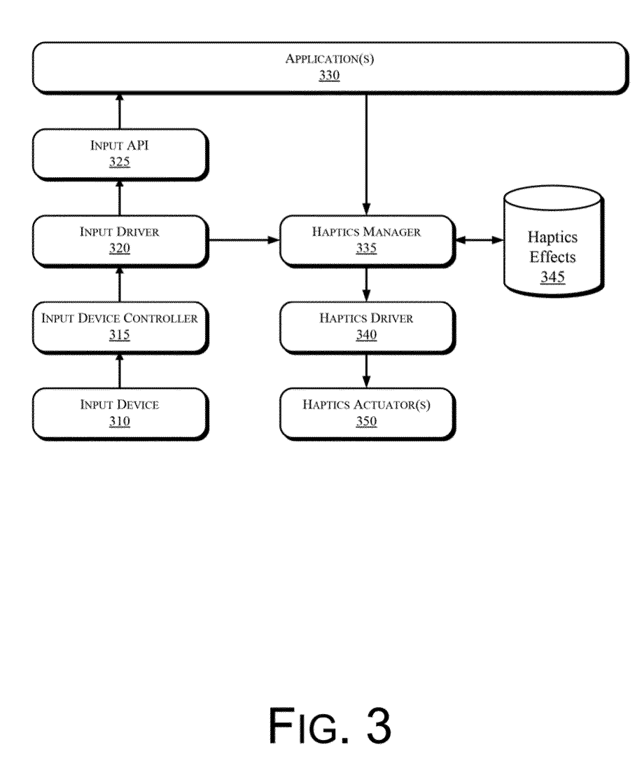

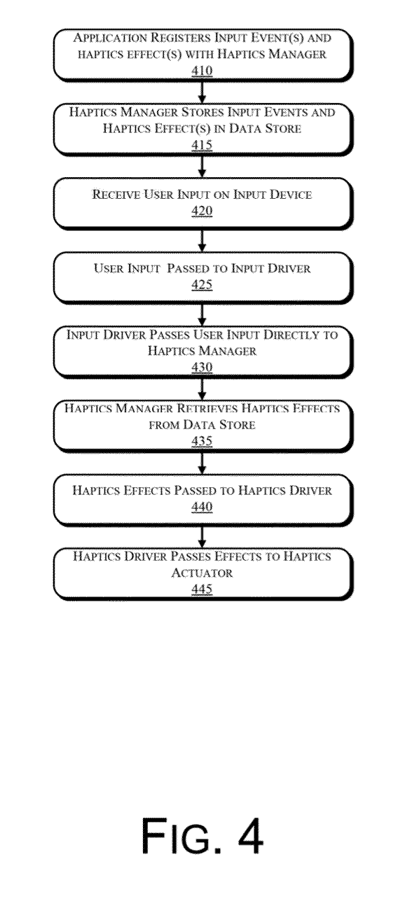

An architecture and associated operations to implement direct haptic feedback are described with reference to FIG. 3 and FIG. 4. FIG. 3 is a schematic illustration of a software stack architecture for the direct haptic feedback in an electronic device, according to embodiments. Referring to FIG. 3,

Operations to implement the direct haptic feedback are described with reference to the flowcharts illustrated in FIG. 3 and FIG. 4. Referring first to FIG. 3, in some embodiments an architecture for haptic feedback comprises an input device 310 which may be coupled to an input device controller 315 and an input driver 320. By way of example, an input device 310 may comprise a touch screen, a touch pad, a keypad, a track ball, or the like. Further, in some embodiments an input device may comprise an accelerometer, a inertial measurement device, (IMU) or the like. The input device controller 315 may be a dedicated integrated circuit device or may be implemented as a portion of a larger integrated circuit. The input driver 320 may be implemented as logic instructions encoded on a tangible computer-readable medium, e.g., as software or firmware.

An input application programming interface (API) 325 provides an interface between the input device stack and one or more applications 330. By way of example, the application(s) may include one or more of a video game, a video playback application, a virtual reality simulator, a virtual keyboard, or any other application that might implement haptic feedback.

Application 330 is coupled to one or more haptics actuators 350 via a haptics manager 335 and one or more haptics drivers 340. Haptics manager 335 and haptics driver 340 may be implemented as logic instructions encoded on a tangible computer-readable medium, e.g., as software or firmware. A data store 345 of haptics effects may be coupled to the haptics manager 335.

In some embodiments, the direct haptics feedback comprises three components. The first component is the haptics manager 335 which manages the input events and haptics effects. The second component is the process of the application registering input events and haptics effects with the haptics manager. The third component is the direct link from the input device 310 to the haptics actuators 350 through the haptics manager 335.

The haptics manager 335 permits the application 330 to register input events to be captured from the input device 310 and the haptic effects that the application 330 seeks to produce when the input events are captured. When registered input events are captured from the input device 310, the haptics manager 335 sends matching haptics effects to the haptics actuator 350 through the haptic driver 340. The haptics manager 335 establishes a direct link from the input device 310 to the haptics actuator 350. With the haptics manager 335, the application 330 does not need to monitor the input events from the input device 310 and then decide what haptics effects to send to the haptics actuator 350. This eliminates the haptics latency caused by the application 330.

Registration of the application 330 with the haptics manager 335 may contain information pertaining to the input events and corresponding haptics effects that upon the occurrence of the input events the corresponding haptics effects would be implemented. The input events may include touch coordinates on the touch screen, touch gestures, motion gestures, or any other events that can be captured by hardware input devices or derived from the software. The haptics effects may include encoded as an index to the haptics effects stored in the haptics effects store 345, or can be actual effects waveforms the application 330 generates from the system memory or copies from a file or any other sources.

Registration of the application 330 with the haptics manager 335 may not be one time throughout the life of the application 330. The application 330 may re-register with the haptics manager 330 with different input events and haptics effects at different time throughout the life of the application 330. Upon closing, the application 330 may un-register with the haptics manager 335.

The input events are captured by the input device 310 together with the input device controller 315 and input driver 320. In some embodiments the input driver may match the input events and send only the matched message to the haptics manager 335. In other embodiments the haptics manager 335 may get all the input data from the input stack including the input device 310, input device controller 315 and input driver 320, and performs the matching function inside the haptics manager 335.

The haptics effects store 345 may be created during the computing device boot up time, generated during the computing device run-time, copied from hard-drive, copied from solid-state drive, copied from flash memory, generated from the system memory, generated from applications, stored on a hard-drive, stored on a solid-state drive, stored in a flash memory, stored in system memory, stored in hardware haptics driver circuits, or generated, created, copied from any other sources and stored in any other form, and format.

The haptics driver 340 may be embodied as in the form of logic instructions stored on a non-transitory computer-readable medium (i.e., software), hardware circuits, or combination of both software and hardware circuits.

The haptics actuators 350 may include one or more of a vibrating motor, a piezoelectric actuator, an electro-active polymer actuator, or electrostatic haptic technology or any other force-based or non-force based devices which generate haptic feedback, or a combination of the above.

FIG. 4 is a flowchart illustrating operations in part of a method to implement haptic feedback in accordance with, according to embodiments. Referring to FIG. 4, at operation 410 an application registers one or more input events and haptics effects with the haptics manager 335. In some embodiments the haptics manager 335 implements a registration process which enables an application to discover haptics actuators and haptics effects stored in the haptics effects store 345 available to haptics manager and to match the capabilities of the available haptics actuators. In other embodiments the application may send new haptics effects that are not available from the haptic effects store 345 to the haptics manager 335 to store into the haptics effects store 345 and register with the haptics manager 335 for input events and the haptics effects. In other embodiments the application may present a listing of input events, which may be coupled with input locations and/or movements, and the haptics manager 335 may implement a matching process between input events and the requested haptics effects. In some embodiments the haptics manager 335 may also register haptics actuators 350 associated with an electronic device their respective capabilities.

By way of example, an application may request that a touch in a specific part of a touch screen or touch pad at a particular point in time will trigger a haptic actuator that generates a vibration effect. Similarly, an application may request that applying a pressure to a joy stick in at a particular point in time will trigger a haptic actuator which generates an opposing force in response to the pressure, possibly in combination with a vibration. In other embodiments the input device may comprise an accelerometer and/or gyroscopic device such as an inertial monitoring unit (IMU) or an inertial reference unit (IRU) which can detect movement and rotation of the device. In such embodiments the application may request that a rotation or movement of the device at a particular point in time will trigger a haptic actuator which generates an opposing force and/or vibration.

At operation 415 the haptics manager 335 constructs profiles of input events and the associated haptics effects and stores the records in the haptics effects data store 345. In some embodiments the haptics manager 335 may also define an input signal for the haptics actuator(s) to achieve the haptics effect requested by the application. The input signal may be stored in the haptics effects data store 345.

In use, at operation 420 a user input is detected on an input device 310. A signal representative of the input is passed from the input device to the input controller and to the input driver 320 (operation 425). At operation 430 the input driver passes the user input and location information directly to the haptics manager 335. Stated otherwise, the user input and location information need not be passed all the way up the stack to the application 330. Bypassing the application reduces the latency associated with haptic feedback.

At operation 435 the haptics manager 335 retrieves one or more haptics effects associated with the user input from the haptics effects data store 345 and passes (operation 440) the haptics effect(s) to the haptics driver 340 which, in turn passes the haptics effect(s) to the haptics actuator(s) 350. By way of example, the haptics manager may generate a signal which activates the haptics actuator(s) to produce the haptics effect(s) associated with the event. The haptics manager 335 may pass the signal to the haptics driver 340, which in turn passes the signal to the haptics actuator 350.

By way of example, a virtual keyboard application may be launched by a user. The virtual keyboard application registers with the haptics manager 335 the key locations or coordinates of the touch screen of the electronics device, and the associated haptics effects for the key pressing events. When the user press a key on the virtual keyboard, the key pressing event is captured by the touch controller input device and passed along the input device driver stack. The finger touch coordinates are passed to the application and to the haptics manager 335. The haptics manager 335 checks the touch coordinates with the touch coordinates registered by the application. When the touch coordinates match the registered touch coordinates, the haptics manager 335 retrieves the haptics effects registered by the application from the haptics effects store 345 and sends the haptics effects to the haptic actuator(s) 350. The haptics actuator(s) 350 then produce the haptics effects.

When the touch coordinates do not match the registered touch coordinates, the haptics manager 335 do not activate the haptics stack and no haptics effects will be produced. In this example, the virtual keyboard application may need to re-register with the haptics manager 335 when the touch screen orientation is changed. The re-registration may reflect the change of the virtual keyboard key coordinates due to the screen orientation change. If the virtual keyboard location is changed, e.g., due to user moving the keyboard to another location on the screen, the virtual keyboard application may also need to re-register with the haptics manager 335 with the new key locations. When the virtual keyboard application is closed, the application may un-register with the haptics manager 335.

By way of another example, a gaming application may be launched by the user. The gaming application displays an initial scene onto the screen of the computing device whereas certain objects in the scene will trigger haptics feedback when user touches the objects. The gaming application may register the locations of the objects and haptics effects with the haptics manager 335. When the application moves to the next scene the objects that need haptics feedback changed, and the application may re-register with the haptics manager 335 with the new input events and haptic effects. The rate of the re-registering may depend on the change rate of the input events. But for touch events triggered haptics application the maxim rate of the registering need not be greater than the display re-fresh rate of the display screen. Upon closing, the application may un-register with the haptics manager.

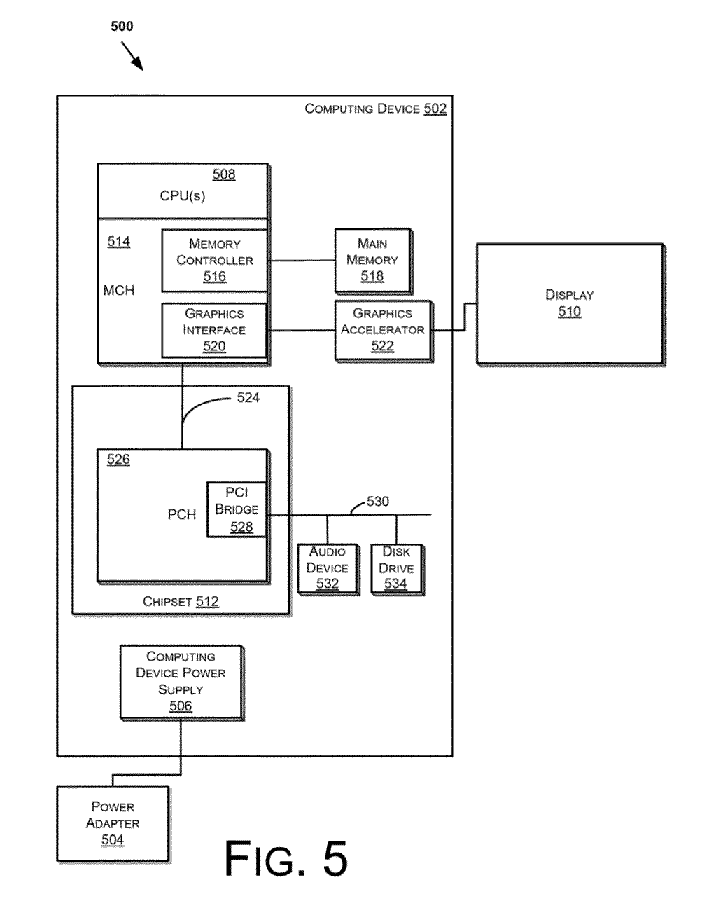

As described above, in some embodiments the electronic device may be embodied as a computer system. FIG. 5 is a schematic illustration of a computer system 500 in accordance with some embodiments. The computer system 500 includes a computing device 502 and a power adapter 504 (e.g., to supply electrical power to the computing device 502). The computing device 502 may be any suitable computing device such as a laptop (or notebook) computer, a personal digital assistant, a desktop computing device (e.g., a workstation or a desktop computer), a rack-mounted computing device, and the like.

Electrical power may be provided to various components of the computing device 502 (e.g., through a computing device power supply 506) from one or more of the following sources: one or more battery packs, an alternating current (AC) outlet (e.g., through a transformer and/or adaptor such as a power adapter 504), automotive power supplies, airplane power supplies, and the like. In some embodiments, the power adapter 504 may transform the power supply source output (e.g., the AC outlet voltage of about 110VAC to 240VAC) to a direct current (DC) voltage ranging between about 5VDC to 12.6VDC. Accordingly, the power adapter 504 may be an AC/DC adapter.

The computing device 502 may also include one or more central processing unit(s) (CPUs) 508. In some embodiments, the CPU 508 may be one or more processors in the Pentium® family of processors including the Pentium® II processor family, Pentium® III processors, Pentium® IV, or CORE2 Duo processors available from Intel® Corporation of Santa Clara, Calif. Alternatively, other CPUs may be used, such as Intel's Itanium®, X [symbol] N and Celeron® processors. Also, one or more processors from other manufactures may be utilized. Moreover, the processors may have a single or multi core design.

A chipset 512 may be coupled to, or integrated with, CPU 508. The chipset 512 may include a memory control hub (MCH) 514. The MCH 514 may include a memory controller 516 that is coupled to a main system memory 518. The main system memory 518 stores data and sequences of instructions that are executed by the CPU 508, or any other device included in the system 500. In some embodiments, the main system memory 518 includes random access memory (RAM); however, the main system memory 518 may be implemented using other memory types such as dynamic RAM (DRAM), synchronous DRAM (SDRAM), and the like. Additional devices may also be coupled to the bus 510, such as multiple CPUs and/or multiple system memories.

The MCH 514 may also include a graphics interface 520 coupled to a graphics accelerator 522. In some embodiments, the graphics interface 520 is coupled to the graphics accelerator 522 via an accelerated graphics port (AGP). In some embodiments, a display (such as a flat panel display) 540 may be coupled to the graphics interface 520 through, for example, a signal converter that translates a digital representation of an image stored in a storage device such as video memory or system memory into display signals that are interpreted and displayed by the display. The display 540 signals produced by the display device may pass through various control devices before being interpreted by and subsequently displayed on the display.

A hub interface 524 couples the MCH 514 to an platform control hub (PCH) 526. The PCH 526 provides an interface to input/output (I/O) devices coupled to the computer system 500. The PCH 526 may be coupled to a peripheral component interconnect (PCI) bus. Hence, the PCH 526 includes a PCI bridge 528 that provides an interface to a PCI bus 530. The PCI bridge 528 provides a data path between the CPU 508 and peripheral devices. Additionally, other types of I/O interconnect topologies may be utilized such as the PCI Expr [symbol] s architecture, available through Intel® Corporation of Santa Clara, Calif.

The PCI bus 530 may be coupled to an audio device 532 and one or more disk drive(s) 534. Other devices may be coupled to the PCI bus 530. In addition, the CPU 508 and the MCH 514 may be combined to form a single chip. Furthermore, the graphics accelerator 522 may be included within the MCH 514 in other embodiments.

Additionally, other peripherals coupled to the PCH 526 may include, in various embodiments, integrated drive electronics (IDE) or small computer system interface (SCSI) hard drive(s), universal serial bus (USB) port(s), a keyboard, a mouse, parallel port(s), serial port(s), floppy disk drive(s), digital output support (e.g., digital video interface (DVI)), and the like. Hence, the computing device 502 may include volatile and/or nonvolatile memory.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “some embodiments” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus, comprising:
logic to:
register one or more input events and one or more haptic effects associated with the one or more input events for an application on an electronic device;
receive an input event;
retrieve one or more haptics effects; and
pass the one or more haptics effects associated with the input event to a haptics actuator.

2. The apparatus of claim 1, further comprising logic to:
construct one or more profiles of input event locations in association with haptics effects; and
store the one or more profiles in association with the haptics effects in a data store.

3. The apparatus of claim 1, wherein the logic to detect an input event on an input device comprises logic to detect at least one of:
a location of an input event on a touch panel coupled to the apparatus;
a direction of movement of an input event on a touch panel coupled to the apparatus;
a rotation of an electronic device coupled to the apparatus; or
depression of a key on a keyboard coupled to the apparatus.

4. The apparatus of claim 1, further comprising logic to:
register one or more haptics actuators; and
store the one or more haptics actuators in association with the haptics effects.

5. The apparatus of claim 4, further comprising logic to:
define an input signal for the one or more haptics actuators to achieve the associated haptics effects.

6. The apparatus of claim 5, wherein the haptics actuator receives the input signal and coverts the input signal to a haptics output.

7. An electronic device, comprising:
an input device;
a haptics actuator; and
logic to:
register one or more input events and one or more haptic effects associated with the one or more input events for an application on the electronic device;
receive an input event;
retrieve one or more haptics effects; and
pass the one or more haptics effects associated with the input event to the haptics actuator.

8. The electronic device of claim 7, further comprising logic to:
construct one or more profiles of input event locations in association with haptics effects; and
store the one or more profiles in association with the haptics effects in a data store.

9. The electronic device of claim 8, wherein the logic to detect an input event on an input device comprises logic to detect at least one of:
a location of an input event on a touch panel coupled to the apparatus;
a direction of movement of an input event on a touch panel coupled to the apparatus;
a rotation of an electronic device coupled to the apparatus; or
depression of a key on a keyboard coupled to the apparatus.

10. The electronic device of claim 8, further comprising logic to:
register one or more haptics actuators; and
store the one or more haptics actuators in association with the haptics effects.

11. The electronic device of claim 10, further comprising logic to:
define an input signal for the one or more haptics actuators to achieve the associated haptics effects.

12. The electronic device of claim 11, wherein the haptics actuator receives the input signal and coverts the input signal to a haptics output.

13. A computer program product comprising logic instructions stored on a tangible computer readable medium which, when executed by a processor in an electronic device, configures the processor to:
register one or more input events and one or more haptic effects associated with the one or more input events for an application on an electronic device;
receive an input event;
retrieve one or more haptics effects; and
pass the one or more haptics effects associated with the input event to a haptics actuator.

14. The computer program product of claim 13, further comprising logic to:
construct one or more profiles of input event locations in association with haptics effects; and
store the one or more profiles in association with the haptics effects in a data store.

15. The computer program product of claim 13, further comprising logic instructions stored on a tangible computer readable medium which, when executed by a processor in an electronic device, configures the processor to detect at least one of:
a location of an input event on a touch panel coupled to the apparatus;
a direction of movement of an input event on a touch panel coupled to the apparatus;
a rotation of an electronic device coupled to the apparatus; or
depression of a key on a keyboard coupled to the apparatus.

16. The computer program product of claim 13, further comprising logic instructions stored on a tangible computer readable medium which, when executed by a processor in an electronic device, configures the processor to:
register one or more haptics actuators; and
store the one or more haptics actuators in association with the haptics effects.

17. The computer program product of claim 16, further comprising logic instructions stored on a tangible computer readable medium which, when executed by a processor in an electronic device, configures the processor to:
define an input signal for the one or more haptics actuators to achieve the associated haptics effects.

18. The computer program product of claim 17, further comprising logic instructions stored on a tangible computer readable medium which, when executed by a processor in an electronic device, configures the processor to:
enable the haptics actuator to receive the input signal and coverts the input signal to a haptics output.

19. A method comprising:
registering one or more haptics actuators; and
registering one or more input events and one or more haptic effects associated with the one or more input events for an application on an electronic device;
associating the one or more haptics actuators in association with the one or more input events;
receiving an input event; and
passing the one or more haptics effects associated with the input event to a haptics actuator.

20. The method of claim 19, further comprising:
constructing one or more profiles of input event locations in association with haptics effects; and
storing the one or more profiles in association with the haptics effects in a data store.

21. The method of claim 20, wherein the detecting an input event on an input device comprises detecting at least one of:
a location of an input event on a touch panel coupled to the apparatus;
a direction of movement of an input event on a touch panel coupled to the apparatus;
a rotation of an electronic device coupled to the apparatus; or
depression of a key on a keyboard coupled to the apparatus.

22. The method of claim 21, further comprising:
defining an input signal for the one or more haptics actuators to achieve the associated haptics effects.

23. The method of claim 22, wherein the haptics actuator receives the input signal and coverts the input signal to a haptics output.
